(19) United States
(12) Patent Application Publication
(10) Pub. No.: US 2014/0041293 A1
(43) Pub. Date: Feb. 13, 2014

(54) Landscape Edging Device and System

(71) Applicant: Thomas N. Kellogg, Euless, TX (US)

(72) Inventor: Thomas N. Kellogg, Euless, TX (US)

(21) Appl. No.: 13/572,016

(22) Filed: Aug. 10, 2012

(51) Int. Cl. A01G 1/08

(52) U.S. Cl. 47/33

(57) ABSTRACT

A landscaping system and apparatus in which a substantially vertical flexible spine member is associated with a plurality of horizontal platform members and substantially vertical lower boundary members, which in conjunction with a bridge to cover gaps between neighboring platforms form a strip on an interior side of a bedding boundary on which lawn care equipment may pass.

### FIELD OF THE TECHNOLOGY

The present application relates generally to a landscaping apparatus and system and, more specifically, to an improved landscaping edging product.

### BACKGROUND

Today, landowners constantly search for products and services to enhance the appearance, value and enjoyment of their property. Residential and commercial property owners alike are aware to the need to constantly maintain and improve the appearance of their property in order to maintain and improve value. Many homeowners regularly embark on home improvement projects of varying size, whether as a “do-it-yourselfer” or through a professional in the relevant field. Commercial property owners and managers, aware of keen competition in, for example, the commercial and residential rental markets, go to great lengths to keep their properties ahead of the competition to attract renters. While one may think of a property's indoors as the focal point of such improvements, much attention must be paid to a property's outdoors in terms of maintenance and improvement. For residential homeowners, a home's curb appeal is an important facet of a home's value. For commercial property owners, the first impression the property makes to a prospective tenant or customer can be the difference between profits and losses.

An important component of preserving and maintaining the exterior of a property is the property's landscaping. Landscaping projects take many forms, from the simple to the elaborate. Many projects may be tackled by a property owner, while landscaping professionals may be better equipped to handle more complex projects. Regardless of the scale or complexity of a landscaping project, landscape edging is a common feature of a vast number of projects.

Landscape edging, in its basic form, serves to physically and visually differentiate between areas of interest in an outdoor area. A common example is use of an edging product to separate a lawn from bedding. The edging in such an application serves at least three purposes. The first is to provide a strip on which a mower or lawn tractor may be directed close to the edge of a bedding area in order to effectively cut and trim grass growing near the edge of a landscaped bed. A second purpose is to prevent some usurpation of grass from the lawn area into the soil or mulched area of the bedding, and similarly to prevent growth from the bedding, such as ivy, ground cover, or flowers, to spread into the lawn. A third purpose is to provide an appealing visual boundary between areas of interest within the property that is created by the prevention of growth between areas.

Many landscape edging products have been available to consumers and professionals for years. A well-known problem with many previously available edging products is that they are typically of the “one-size-fits-all” variety. For example, many prior art edging products are either strictly straight-edge products allowing for resulting edging that is only straight lined or right angled. Some curved products are pre-fabricated with a static curvature radius. Such pre-cut and pre-shaped products are often ill-suited for the project of interest.

Another drawback with known edging products is that although these products are intended to provide a physical boundary between areas of interest, additional maintenance is required to actually keep separation of distinct areas such as lawn and bedding. For example, vertical edging products that form a boundary between a lawn and bedding nevertheless require that grass near the boundary be cut regularly to prevent grass from growing in the bedding area. While a homeowner or lawn care specialist may cut the grass near the vertical edging product with a push-mower or lawn tractor, that equipment may not pass so close to the edging that sufficient cutting ensues. Consequently, the homeowner or lawn care provider would be required to manually trim at or near the edging if they wish to create a clean and neat appearance by cutting the remaining grass that the mower or lawn tractor did not reach. This extra step results in the loss of time and added expense to the lawn care process. In addition, the process of trimming along the edging with a power trimmer or hand trimmer causes damage to the edging. Repeated contact by a blade or line of a power or hand trimmer causes chipping and peeling of paint from the edging product, causing unsightly rust on metal edging. Such a condition will eventually prompt the need for repainting or even replacing the product.

An advance in the field of landscape edging is needed that provides the necessary boundary between areas of interest with accompanying ease of maintaining the surrounding areas. The ability to form the edging product to fit the parameters for the most complex projects is also desired.

### SUMMARY

A landscape edging system is described having a substantially vertical flexible spine extending in an upward direction, a plurality of substantially horizontal platforms associated with the spine member, a plurality of substantially vertical boundary members extending in a downward direction, each associated with one of the plurality of platforms and an expandable and contractible gap formed between neighboring platforms, wherein a bridge associated with the spine extends across the gap.

Before undertaking the detailed description below, it may be advantageous to set forth definitions of certain words and phrases used in connection to the disclosed exemplary embodiments: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

### BRIEF DESCRIPTION OF THE DRAWINGS

For a more complete understanding of the present embodiments and their advantages, reference is now made to the following description taken in conjunction with the accompanying drawings, in which like reference numerals represent like parts:

FIG. 1 is a perspective view of an embodiment of the present landscape edging system.

FIGS. 2A, 2B and 2C are perspective views of various embodiments of the present landscape edging system.

FIG. 3 is a cross-sectional view of an embodiment of the present landscape edging system.

FIG. 4 depicts an aerial view of an embodiment of the present landscape edging system.

### DETAILED DESCRIPTION OF THE EMBODIMENTS

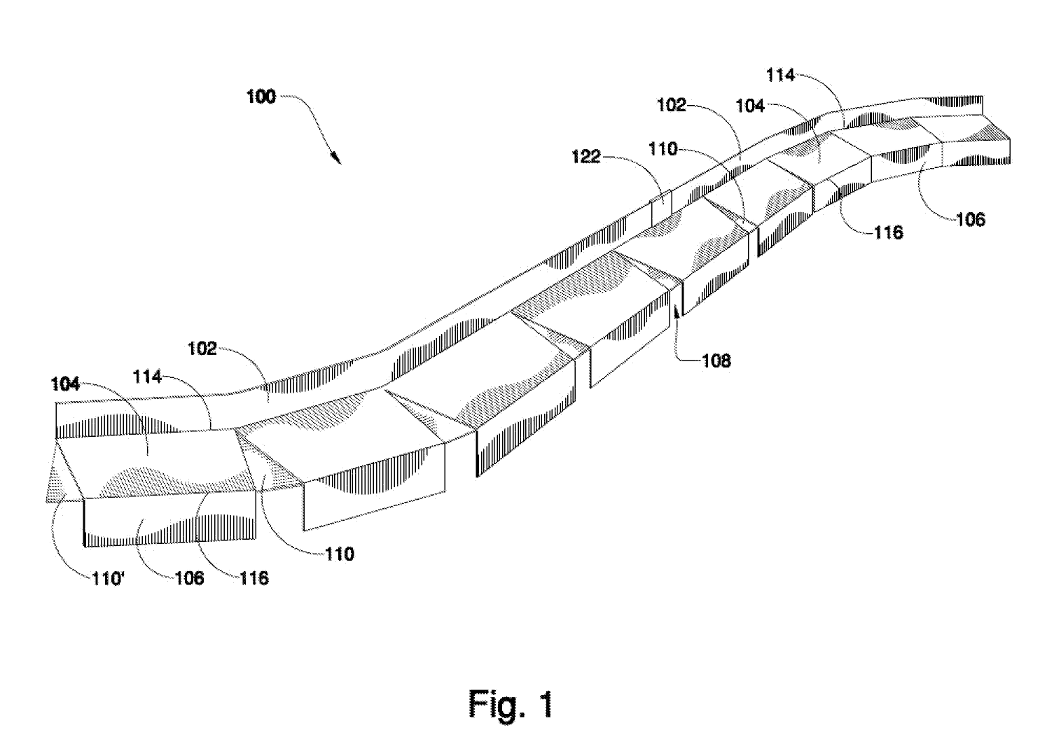

FIGS. 1 through 4, discussed below, and the various descriptions of the embodiments disclosed herein are by way of illustration only and should not be construed as limiting. Those skilled in the art will understand that the principles of the present disclosure may be implemented in suitable landscaping edging systems.

FIG. 1 depicts an exemplary embodiment of the present landscape edging system. In FIG. 1, a section 100 of the present landscape edging system is shown. A section 100 includes a substantially vertical spine 102 that spans the horizontal length of section 100. Attached in a substantially perpendicular configuration to spine 102 is a series of substantially horizontal platform members 104. Each platform member 104 joins spine 102 along all or part of an inner edge 114 of platform member 104.

A series of substantially vertical lower boundary members 106 are connected to an outer edge 116 of each platform member 104. The relationship between each lower boundary member 106 and each platform member 104 is substantially perpendicular. In one embodiment, platform member 104 is substantially trapezoidal in shape. As such, the connection of multiple platform members 104 along spine 102 results in a substantially v-shaped gap 108 formed between neighboring platform members. Each v-shaped gap 108 is broadened or narrowed depending on the curvature of spine 102 applied during installation of edging section 100. For example, if edging section 100 is installed in a concave manner, each v-shaped gap 108 will be narrowed. On the other hand, if edging section 100 is installed in a convex manner, each v-shaped gap 108 will be broadened.

To help prevent grass from growing up into the v-shaped gaps 108, these v-shaped gaps 108 are covered by gap spanners 110. In one embodiment, gap spanners 110 are affixed to spine 102 at a point substantially aligned with the vertex of the v-shaped gap 108. Each gap spanner 110 is of a width that exceeds the opening formed between neighboring platform members 104. In other words, when neighboring platform members 104 are at a distance apart, the v-shaped gap 108 formed between neighboring platform members 104 will be covered by gap spanner 110. As seen in FIG. 1, a plurality of gap spanners 110 are affixed at locations along spine 102 and in alignment with a corresponding plurality of v-shaped gaps 108. This provides coverage within an edging section 100 of each v-shaped gap 108 to prevent unwanted growth. That gap spanners 110 are fixed within each edging section at spine 102, but not fixed to the corresponding platform members 104, allows each platform member 104 to move freely in relation to each gap spanner 110. Thus, a single sized gap spanner 110 accommodates any number of positions in which edging section 100 is installed and allows each gap spanner 110 to cover a corresponding v-shaped gap 108, even when the v-shaped gap 108 is widened or narrowed through bending or curving an edging section 100 to achieve a desired configuration. In this manner, there is continuity between platform members 104. This continuity prohibits vegetative growth between platform members that could otherwise penetrate into unwanted areas. In addition, the gap spanners 110 in conjunction with platform members 104 provide a substantially flat and continuous surface on which the wheels of a tractor or mower may pass.

The flexibility of spine 102 allows for multiple configurations of a single edging section 100 or multiple joined edging sections 100. For example, if a single or combination of edging sections 100 are arranged in an s-shaped curve, this curvature within certain sections of the system will cause the v-shaped gaps 108 to expand and contract according to movement of neighboring platform members 104 that form the v-shaped gaps 108. That gap spanners 110 are attached to spine 102 allows the v-shaped gaps 108 formed between neighboring platform members 104 to remain covered with the expansion or contraction of the v-shaped gaps caused by various positioning of spine 102.

At one end of edging section 100 is situated a gap spanner connector 110′. In FIG. 1, this gap spanner connector 110′ is located at the left end of section 100. Once two edging sections 100 are installed in series, gap spanner connector 110′ serves to span a v-shaped gap formed between the last platform member 104 of a first edging section 100 and the first platform member 104 of a second edging section 100. Gap spanner connector 110′ accounts for and covers a v-shaped gap 108 formed between platform members 104 located on the ends of neighboring edging sections 100, just as gap spanners 110 cover v-shaped gaps 108 formed between platform members 104 within an edging section 100.

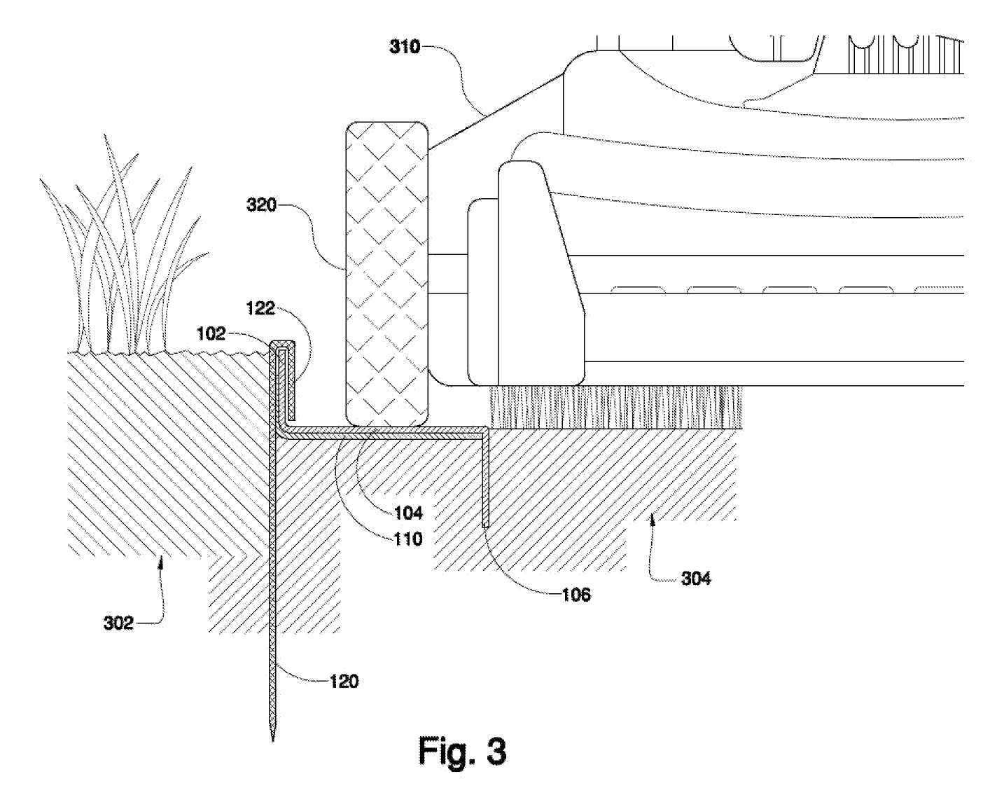

FIG. 3 illustrates a cross sectional view of edging section 100. In FIG. 3, edging section 100 is installed to separate and serve as a boundary between a bedding area 302 and lawn area 304. Edging section 100, however, may be installed as a boundary between any areas of interest comprising any types of materials. As shown, edging section 100 is constructed in a step shaped configuration, providing separation between the bedding area 302, which is typically higher in elevation than a lawn area 304. This step shaped configuration provides a barrier preventing most grass from lawn area 304 from penetrating and taking root within bedding area 302, and vice versa. The upper level formed by the union of spine 102 and platform member 104 is at a higher elevation than lawn area 304 and serves to keep materials often found in bedding area 302, such as mulch, from spilling or blowing into lawn area 304. Platform member 104 is substantially horizontal in relation to the upper surface of lawn area 304. Each lower boundary member 106 is inserted into or penetrates the ground within lawn area 304 so as to form a first boundary on the lawn area side of the area of interest.

Each edging section 100 is further secured in the ground with stakes 120. In one embodiment, stakes 120 may be installed at intervals on spine 102. In one embodiment, each stake 120 is secured onto spine 102 with integrated clip 122. As seen in FIG. 3, clip 122 is formed from an upper end of stake 120 and is constructed of a width enabling it to fit snugly onto spine 102. As an alternative embodiment, stakes 120 may be inserted within horizontal slots formed within spine 102. The slots have a width and thickness slightly larger than the width and thickness of stake 120, enabling insertion of the stake within the slot. Each stake 120 is of a length sufficient to penetrate the ground surrounding edging section 100 and secure edging section 100.

The substantially horizontal platform member 104 serves as a surface or strip for a mower or lawn tractor. For example, in FIG. 3 wheels 320 of mower 310 may be operated along platform 104. Platform member 104 thus allows cutting of grass cleanly within lawn area 304 at the junction of platform member 104 and lower boundary member 106 that grows to an elevation higher than platform member 104 without the need for manual trimming or edging. As seen in FIG. 3, even if wheels 320 of mower 310 are not directed completely against the interior edge of spine 102, sufficient cutting of grass growing at the junction of platform member 104 and boundary member 106 takes place because the platform enables the cutting area of mower 310 to completely encompass the junction area. In this manner, damaging and time consuming trimming and edging, either manually or with power equipment, may be avoided.

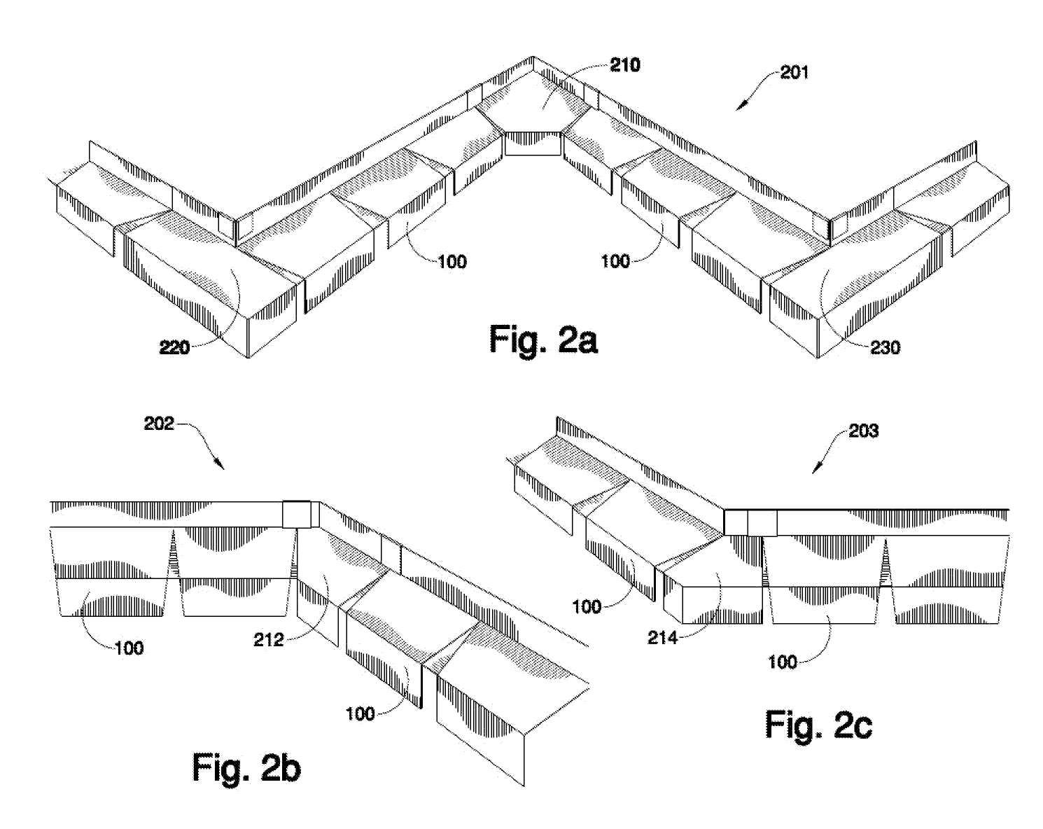

In an exemplary embodiment of the present landscape edging system, multiple edging sections 100 will be installed in a variety of configurations to serve as a boundary of various areas of interest. Along substantially straight spans of multiple edging sections 100, each edging section 100 may be installed end-to-end and secured in place with stakes 120. At various points in the project, however, separate edging sections may be installed at significant angles in relation to one another. FIGS. 2A, 2B and 2C depict examples of embodiments of intersection joints that are used to connect edging sections 100. In FIG. 2A, multiple edging sections 100 are configured in a saw tooth type of pattern. Different intersection joints are employed in this arrangement to produce the right angled turns of the system 201. At the center of the arrangement depicted in FIG. 2A, an interior right angled connection joint 210 provides an interface between edging sections 100 connecting to the interior right angled connection joint 210 on either side. FIG. 2A also includes exterior right angled connection joints 220 and 230. These right angled connectors may be used in any combination with edging sections 100 to create an arrangement containing multiple right angles.

FIG. 2B depicts a system 202 of edging sections 100 joined by an interior acute angled connection joint 212. This interior acute angled connection joint 212 may be manufactured having an interior angle of between 0 and 90 degrees relative to a straight line connection of the joined edging sections. Similarly, FIG. 2C depicts a system 203 of edging sections 100 joined by an exterior acute angled connection joint 214. This exterior acute angled connection joint 214 may be manufactured having an exterior angle of between 0 and 90 degrees relative to a straight line connection of the joined edging sections. The connection joints described above have a similar profile as edging section 100 in that they have the “stair-step” type of configuration as does edging section 100. The connection joints receive on each side an end of an edging section 100 to provide a continuous chain of edging sections 100 having a similar profile and a continuous boundary. The connection joints may be constructed of the same material as edging sections 100 or may be constructed of any other suitable material.

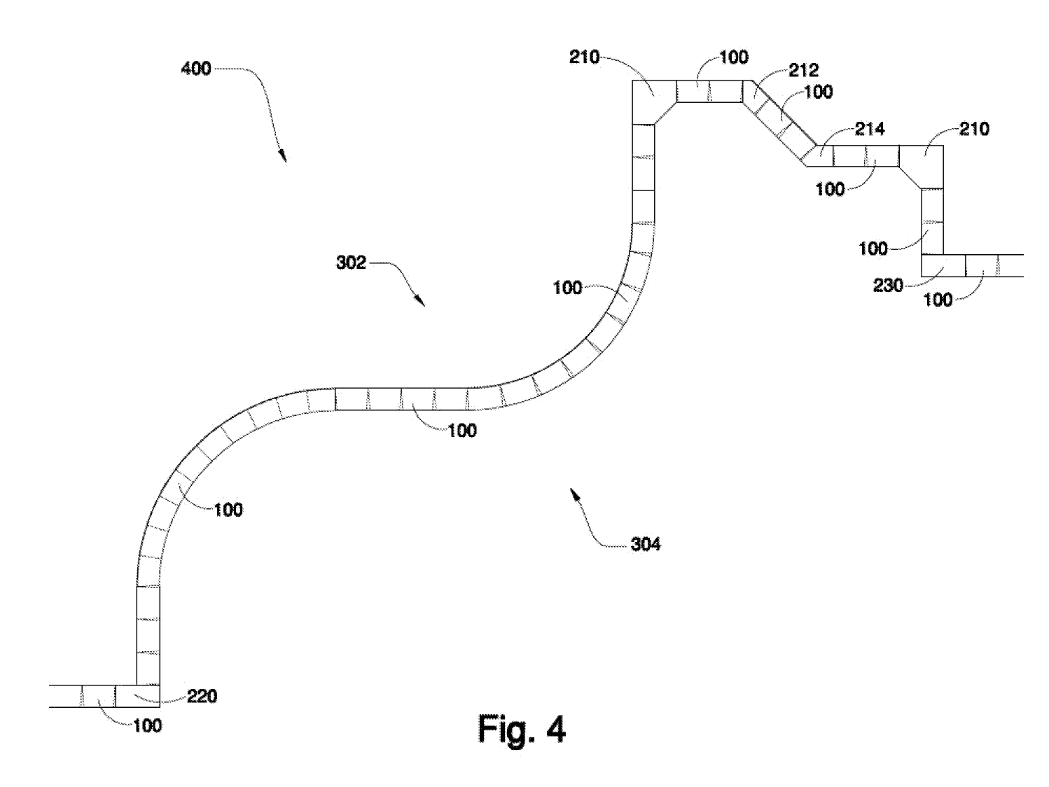

In FIG. 4, an aerial view of an installed network 400 of a plurality of edging sections 100 is shown. In network 400, multiple edging sections 100 are installed in a variety of configurations. In various parts of network 400, edging sections 100 are arranged in a substantially perpendicular configuration in relation to one another. In such configurations, edging sections 100 are joined by various right angled connection joints discussed above. Specifically, as seen in FIG. 4, exterior right angled connection joints 220 and 230 connect edging sections 100. An interior acute angled connection joint 212 is also shown that connects two edging sections 100. An exterior acute angled connection joint 214 joining two edging sections 100 is also shown. In the system of FIG. 4, interior and exterior acute angled connection joints 212 and 214 form an approximately forty-five degree angle in relation to one another. However, the acute angled connection joints may be manufactured at other angles to meet the needs of a particular application. At each such point of connection, one end of each such edging section meets one side of an intersection joint. For example, interior right angled connection joint 210 serves as a connector at the substantially right angle formed by the two edging sections 100 that meet at that point. In one embodiment, intersection joint 210 is made of the same material as edging sections 100 and is constructed to have the same stepped profile as edging section 100.

In another embodiment of the present edging system, each lower boundary member 106 is a 2-inch substantially vertical section that is buried virtually entirely into the soil, forming a lower, interior interface between the lawn area and bedding area. Platform member 104 is associated with lower boundary member 106 in a substantially perpendicular relationship. In one embodiment, platform member 104 is 4 inches in width that lays flush with the lawn surface. The spine 102 is associated with platform member 104 that extends upward in a substantially perpendicular relationship to the platform member 104. In one embodiment, the spine 102 is 1½ inches in height, forming an upper, exterior interface between the bedding area and lawn area. The 1½ inch spine 102 is also staked at intervals. The 4 inch wide platform member 104 provides a mow strip, allowing the wheels on one side of a push lawn mower or tractor to ride on top of the platform in order to cut the lawn with a clean edge. Because the grass directly adjacent to the mow strip would be cut with the lawn mower or tractor, the need for maintenance personnel to return after mowing in order to string trim the grass is reduced or eliminated. This would provide a savings in time and expense. The sizes and the relationship between the sizes of the spine 102, platform member 104 and lower boundary member 106 are provided for illustrative purposes and in no way limit the sizes or proportions in which the present edging system may be manufactured. While dimensions of one embodiment of the present edging system are described, the present edging system may be constructed at any size and dimension, depending on location, application and project scale.

In an embodiment of the present edging system, components are constructed of steel and finished with powder coating. Varying gauges of steel are be available for different applications. Systems for residential or light commercial use could be constructed from 16 or 18 gauge steel. Systems may also be constructed of any suitable materials, such as aluminum or plastic of various thickness. Components include straight edging sections in a variety of lengths. In an exemplary embodiment, sections are constructed in 4 foot and 8 foot lengths. Section 100 may be arranged to provide curves of various inside or outside radiuses, with section lengths matching the lengths of straight sections. Various joint pieces for joining edging sections at angles ranging from 0 to 90 degree angles are included as part of the system. In another embodiment, a protective vinyl trim cap for the top edge of the spine section 102 is provided as a safety feature in areas subject to pedestrian traffic or frequented by children.

Although the subject matter of this application has been described with reference to illustrative embodiments, this description is not intended to be construed in a limiting sense. Various modifications and combinations of the illustrative embodiments as well as other embodiments will be apparent to persons skilled in the art upon reference to the description. It is, therefore, intended that the appended claims encompass any such modifications or embodiments.

### ADDITIONAL DISCLOSURE

Clause 1: A landscaping apparatus, comprising:

a substantially vertical flexible spine extending in an upward direction;

a plurality of substantially horizontal platforms associated with the spine;

a plurality of substantially vertical boundary members extending in a downward direction, each associated with one of the plurality of platforms;

an expandable and contractible gap between neighboring platforms; and

a bridge associated with the spine extending over the gap.

Clause 2: The landscaping apparatus of clause 1, wherein the gap is a space between an edge of a first substantially horizontal platform and an edge of a second substantially horizontal platform.

Clause 3: The landscaping apparatus of clauses 1 or 2, wherein the bridge is moveably associated with the edge of the first substantially horizontal platform and the edge of a second substantially horizontal platform.

Clause 4: The landscaping apparatus of clauses 1, 2 or 3, wherein the bridge extends past the edge of the first substantially horizontal platform and the edge of the second substantially horizontal platform.

Clause 5: The landscaping apparatus of clauses 1, 2, 3, or 4, wherein the bridge is associated with the edge of a first substantially horizontal platform and the edge of a second substantially horizontal platform as the gap is expanded.

Clause 6: The landscaping apparatus of clauses 1, 2, 3, 4, or 5, wherein the bridge is associated with the edge of a first substantially horizontal platform and the edge of a second substantially horizontal platform as the gap is contracted.

Clause 7: The landscaping edging apparatus of clauses 1, 2, 3, 4, 5, or 6, wherein the gap is expanded from a rest position when the substantially vertical flexible spine is arranged in a convex position.

Clause 8: The landscaping edging apparatus of clauses 1, 2, 3, 4, 5, 6, or 7, wherein the gap is contracted from a rest position when the substantially vertical flexible spine is arranged in a concave position.

Clause 9: A landscaping system, comprising:

a plurality of landscaping edging sections, each landscaping edging section comprising:
a plurality of substantially horizontal platforms;
a spine associated with the plurality of horizontal platforms; and
a plurality of substantially vertical boundary panels associated with the plurality of horizontal platforms;
an expandable and contractible gap between neighboring horizontal platforms; and
a plurality of bridges spanning the gap formed between neighboring horizontal platforms; and
a plurality of stakes detachably secured to the spine.

Clause 10: The landscaping system of clause 9, further comprising: a connector associated with a first of the plurality of landscaping edging sections and a second of the plurality of landscaping edging sections.

Clause 11: The landscaping system of clauses 9 or 10, wherein the first and second of the plurality of landscaping edging sections associated with the connector are arranged at a substantially right angle in relation to each other.

Clause 12: The landscaping system of clauses 9, 10, or 11, wherein the first and second of the plurality of landscaping edging sections associated with the connector are arranged at an acute angle in relation to each other.

Clause 13: The landscaping system of clauses 9, 10, 11, or 12, wherein the gap is a space between an edge of a first substantially horizontal platform and an edge of a second substantially horizontal platform.

Clause 14: The landscaping system of clauses 9, 10, 11, 12, or 13, wherein the bridge is moveably associated with the edge of the first substantially horizontal platform and the edge of a second substantially horizontal platform.

Clause 15: The landscaping system of clauses 9, 10, 11, 12, 13, or 14, wherein the bridge extends past the edge of the first substantially horizontal platform and the edge of the second substantially horizontal platform.

Clause 16: The landscaping system of clauses 9, 10, 11, 12, 13, 14, or 15, wherein one of the plurality of bridges is associated with the edge of the first substantially horizontal platform and the edge of the second substantially horizontal platform as the gap is expanded.

Clause 17: The landscaping system of clauses 9, 10, 11, 12, 13, 14, 15, or 16, wherein one of the plurality of bridges is associated with the edge of the first substantially horizontal platform and the edge of the second substantially horizontal platform as the gap is contracted.

Clause 18: A landscaping edging apparatus, comprising:

a flexible spine;
a plurality of substantially horizontal platforms associated with the spine;
a plurality of substantially vertical boundary members extending in a downward direction, each associated with one of the plurality of platforms; and
a v-shaped gap between neighboring platforms, and
a bridge associated with the spine extending over the gap.

Clause 19: The landscaping edging apparatus of clause 18, wherein the v-shaped gap expands from a rest position as the substantially vertical flexible spine is arranged in a convex position.

Clause 20: The landscaping edging apparatus of clauses 18 or 19, wherein the v-shaped gap contracts from a rest position as the substantially vertical flexible spine is arranged in a concave position.

1. A landscaping apparatus, comprising:
a substantially vertical flexible spine extending in an upward direction;
a plurality of substantially horizontal platforms associated with the spine;
a plurality of substantially vertical ground penetrating boundary panels extending in a downward direction, each associated with one of the plurality of platforms;
an expandable and contractible gap between neighboring platforms; and
a bridge associated with the spine extending over the gap,
wherein the plurality of substantially horizontal platforms move independently of the bridge, and
wherein each of the plurality of substantially vertical ground penetrating boundary panels has a lower edge for insertion into a local ground surface area.

2. The landscaping apparatus of claim 1, wherein the gap is a space between an edge of a first substantially horizontal platform and an edge of a neighboring second substantially horizontal platform.

3. The landscaping apparatus of claim 2, wherein the bridge is moveably associated with the edge of the first substantially horizontal platform and the edge of the neighboring second substantially horizontal platform.

4. The landscaping apparatus of claim 3, wherein the bridge extends past the edge of the first substantially horizontal platform and the edge of the second substantially horizontal platform.

5. The landscaping apparatus of claim 4, wherein the bridge is not fixed to the edge of the first substantially horizontal platform and the edge of the neighboring second substantially horizontal platform as the gap is expanded.

6. The landscaping apparatus of claim 4, wherein the bridge is not fixed to the edge of the first substantially horizontal platform and the edge of the neighboring second substantially horizontal platform as the gap is contracted.

7. The landscaping edging apparatus of claim 1, wherein the gap is expanded from a rest position when the substantially vertical flexible spine is arranged in a convex position.

8. The landscaping edging apparatus of claim 1, wherein the gap is contracted from a rest position when the substantially vertical flexible spine is arranged in a concave position.

9. A landscaping system, comprising:
a plurality of landscaping edging sections, each landscaping edging section comprising:
a plurality of substantially horizontal platforms;
a substantially vertical flexible spine associated with the plurality of horizontal platforms; and
a plurality of substantially vertical boundary panels associated with the plurality of horizontal platforms;
an expandable and contractible gap between neighboring horizontal platforms; and
a plurality of bridges spanning the gap formed between neighboring horizontal platforms; and
a plurality of stakes detachably secured to the substantially vertical flexible spine,
wherein the plurality of substantially horizontal platforms move independently of the bridge, and
wherein each of the plurality of substantially vertical ground penetrating boundary panels has a lower edge for insertion into a local ground surface area.

10. The landscaping system of claim 9, further comprising: a connector associated with a first of the plurality of landscaping edging sections and a second of the plurality of landscaping edging sections.

11. The landscaping system of claim 10, wherein the first and second of the plurality of landscaping edging sections associated with the connector are arranged at a substantially right angle in relation to each other.

12. The landscaping system of claim 10, wherein the first and second of the plurality of landscaping edging sections associated with the connector are arranged at an acute angle in relation to each other.

13. The landscaping edging system of claim 9, wherein the gap is a space between an edge of a first substantially horizontal platform and an edge of a neighboring second substantially horizontal platform.

14. The landscaping edging system of claim 13, wherein the bridge is moveably associated with the edge of the first substantially horizontal platform and the edge of the neighboring second substantially horizontal platform.

15. The landscaping edging system of claim 13, wherein the bridge extends past the edge of the first substantially horizontal platform and the edge of the neighboring second substantially horizontal platform.

16. The landscaping apparatus of claim 13, wherein one of the plurality of bridges is not fixed to the edge of the first substantially horizontal platform and the edge of the neighboring second substantially horizontal platform as the gap is expanded.

17. The landscaping apparatus of claim 13, wherein each one of the plurality of bridges is not fixed to the edge of the first substantially horizontal platform and the edge of the neighboring second substantially horizontal platform as the gap is contracted.

18. A landscaping edging apparatus, comprising:
a substantially vertical flexible spine;
a plurality of substantially horizontal platforms associated with the spine;
a plurality of substantially vertical ground penetrating boundary members extending in a downward direction, each associated with one of the plurality of platforms;
a plurality of stakes detachably secured to the substantially vertical flexible spine;
a v-shaped gap between neighboring platforms; and
a bridge associated with the spine extending over the gap,
wherein the plurality of substantially horizontal platforms move independently of the bridge, and
wherein each of the plurality of substantially vertical ground penetrating boundary members has a lower edge for insertion into a local ground surface area.

19. The landscaping edging apparatus of claim 18, wherein the v-shaped gap expands from a rest position as the substantially vertical flexible spine is arranged in a convex position.

20. The landscaping edging apparatus of claim 18, wherein the v-shaped gap contracts from a rest position as the substantially vertical flexible spine is arranged in a concave position.

21. The landscaping edging apparatus of claim 18, wherein the plurality of substantial horizontal platforms and the plurality of bridges form a substantially planar surface when the gap is partially contracted.

22. The landscaping edging apparatus of claim 9, wherein the plurality of substantial horizontal platforms and the bridge form a substantially planar surface when the gap is partially contracted.

23. The landscaping edging apparatus of claim 1, wherein the plurality of substantial horizontal platforms and the plurality of bridges form a substantially planar surface when the gap is partially contracted.
